(19) United States
(12) Patent Application Publication
(10) Pub. No.: US 2016/0175189 A1
(43) Pub. Date: Jun. 23, 2016

(54) METHOD, SYSTEM AND APPARATUS FOR COMMUNICATING WITH AN ELECTRONIC DEVICE AND A STEREO HOUSING

(71) Applicant: Robert Louis Fils, Los Gatos, CA (US)

(72) Inventor: Robert Louis Fils, Los Gatos, CA (US)

(21) Appl. No.: 14/979,930

(22) Filed: Dec. 28, 2015

Related U.S. Application Data
(63) Continuation-in-part of application No. 14/225,822, filed on Mar. 26, 2014.
Application No. 14/225,822 is a continuation-in-part of application No. 13/858,511, filed on Apr. 8, 2013.

(51) Int. Cl. A61H 33/00; G05B 15/02; G06F 3/16

(52) U.S. Cl. CPC A61H 33/005; G06F 3/165; G05B 15/02; A61H 2033/0079

(57) ABSTRACT

An electronic device is coupled with a system and a device for controlling one or more components of a pool or a spa. The electronic device is substantially sealed from water and environmental intrusion to a desired protection level and located within a housing that is able to be coupled with a pool and/or a spa frame. A screen is able to display visual content based on content of the electronic device. The visual content is able to comprise song, album, and artist information and caller identification information of a call received by the electronic device. The system and device is usable to control one or more components of the pool and/or the spa.

### RELATED APPLICATIONS

This Patent Application is a continuation-in-part of the U.S. patent application Ser. No. 14/225,822, filed on Mar. 26, 2014, and entitled, METHOD, SYSTEM AND APPARATUS FOR COMMUNICATING WITH AN ELECTRONIC DEVICE AND A STEREO HOUSING, which is a continuation-in-part of the U.S. patent application Ser. No. 13/858,511, filed on Apr. 8, 2013, and entitled, METHOD, SYSTEM AND APPARATUS FOR COMMUNICATING WITH AN ELECTRONIC DEVICE AND A STEREO HOUSING, which is hereby incorporated by reference in its entirety.

### FIELD OF THE INVENTION

The present invention relates to controlling an electronic device coupled to a docking station or stereo system. More particularly, the present invention relates to remotely controlling an electronic device and a hermetically sealed docking station or stereo system.

### BACKGROUND OF THE INVENTION

Portable digital media players and electronic devices allow consumers to carry their music and other media with them wherever they go. Devices such as the iPod™, iPhone™, Android devices, and other electronic devices are rapidly gaining popularity. Particularly, it is often desirable for a user to listen to music or use their electronic device in numerous locations, such as in the car, outside, or while performing an activity. In order to enhance the use of the electronic device, it is often connected to an external audio system or docking station. In some instances, a user is able to place the electronic device in one location and communicate with an audio system which is located in a separate location. Alternatively, the electronic device is coupled with a docking station and played through a speaker system of the docking station. However, once the electronic device is coupled with the external audio system or docking station it is difficult to control the electronic device as the user moves around or accomplishes a task.

### SUMMARY OF THE INVENTION

An electronic device is coupled with a system and a device for controlling one or more components of a pool or a spa. The electronic device is hermetically sealed from water and environmental intrusion within a housing that is able to be coupled with a pool and/or a spa frame. A screen is able to display visual content based on content of the electronic device. The visual content is able to comprise song, album, and artist information and caller identification information of a call received by the electronic device. The system and device is usable to control one or more components of the pool and/or the spa.

In one aspect, a control device for an aquatic environment comprises a housing configured to fit within a frame of the aquatic environment, a body movable into and out of the housing and a cover that covers the body when it is in the housing, the body comprising a control pad for controlling one or more components of the pool or the spa. Particularly, the control pad is usable from within the pool and outside of the pool. In some embodiments, touch pad is configured to control one or more of an audio system and one or more pool or spa jets. The cover is rotatable to an open position and the body is configured to move out of the housing when the cover is rotated to the open position. Alternatively, in some embodiments, the cover is slidable to an open position and the body is configured to move out of the housing when the cover is slid to the open position. The body is configured to pop up and out of the housing. In some embodiments, the body is rotatable when it is out of the housing. In further embodiments, the body is tiltable when it is out of the housing. In some embodiments, the body comprises a touch screen for controlling the one or more components of the pool or the spa. In some of these embodiments, the body comprises a touch screen on a front side of the body and a back side of the body. In some embodiments, the control device is controllable from a remotely located electronic device. In some embodiments, the control device is configured to receive voice commands. In some embodiments, the control device comprises a noise cancellation device for cancelling ambient noise. In some embodiments, the control device utilizes one or more of infrared, infrared laser, radio frequency, wireless, WiFi, Bluetooth®, 2.4 Gh, IAP, and A2DP protocol. The aquatic environment can comprise one of a pool, a spa, a steam room and a sauna.

In another aspect, a control system for an aquatic environment comprises a housing configured to fit within a frame of the aquatic environment, a body movable into and out of the housing, the body comprising a compartment for receiving an electronic device, and a cover that covers the body when it is in the housing, the body comprising a control pad for controlling the electronic device. In some embodiments, the compartment comprises a docking station for the electronic device. In some embodiments, the system wirelessly communicates with the electronic device. The housing substantially seals the body when it is in the housing. In some embodiments, the housing seals the body with an IP rating of 4 when it is in the housing. In further embodiments, the housing seals the body with an IP rating of 5 when it is in the housing. In some embodiments, the system comprises a remote control for controlling the system. The electronic device is usable with an audio system of the pool or spa when it is located within the body. In some embodiments, the control device is controllable from a remotely located electronic device. In some embodiments, the system is configured to receive voice commands. In some embodiments, the system comprises a noise cancellation device for cancelling ambient noise. In some embodiments, the system utilizes one or more of infrared, infrared laser, radio frequency, wireless, WiFi, Bluetooth®, 2.4 Gh, IAP, and A2DP protocol. The aquatic environment can comprise one of a pool, a spa, a steam room and a sauna.

In a further aspect, a controller for an aquatic environment comprises a body comprising an internal cavity for accepting an electronic device and a cover comprising a control pad for controlling the electronic device, wherein the controller is configured to removably couple with an existing controller coupled to the aquatic environment. In some embodiments, the spa controller is configured to control one or more components of the pool or the spa. In some embodiments, the spa controller is configured to control the one or more components of the pool or the spa when separated from the existing spa controller. In some embodiments, the compartment comprises a docking station for the electronic device. In further embodiments, the system wirelessly communicates with the electronic device. The housing substantially seals the body when it is in the housing. In some embodiments, the housing seals the body with an IP rating of 4 when it is in the housing. In some embodiments, the housing seals the body with an IP rating of 5 when it is in the housing. The electronic device is usable with an audio system of the pool or spa when it is located within the body. In some embodiments, the controller is configured to receive voice commands. In some embodiments, the controller comprises a noise cancellation device for cancelling ambient noise. In some embodiments, the controller utilizes one or more of infrared, infrared laser, radio frequency, wireless, WiFi, Bluetooth®, 2.4 Gh, IAP, and A2DP protocol. The aquatic environment can comprise one of a pool, a spa, a steam room and a sauna.

### BRIEF DESCRIPTION OF THE DRAWINGS

FIG. 1 illustrates a stereo system in accordance with some embodiments.

FIG. 2 illustrates a schematic view showing the components of a communication system for a stereo housing an electronic device in accordance with some embodiments.

FIG. 3 illustrates a method of remotely operating a stereo housing and an electronic device in accordance with some embodiments.

FIG. 4 illustrates a remote control in communication with a housing unit and an electronic device, in accordance with some embodiments.

FIG. 5 illustrates a schematic view showing the components of a audio system in accordance with some embodiments.

FIG. 6 illustrates a remote control in communication with a housing unit and an electronic device, in accordance with some embodiments.

FIG. 7 illustrates a method of operating an audio system in accordance with some embodiments.

FIGS. 8A-8D illustrate a control device for a pool or a spa in accordance with some embodiments.

FIGS. 9A and 9B illustrate a control system for a pool or a spa in accordance with some embodiments.

FIGS. 10A-10C illustrate a controller for a pool or a spa in accordance with some embodiments.

### DETAILED DESCRIPTION OF THE PREFERRED EMBODIMENT

In the following description, numerous details and alternatives are set forth for purpose of explanation. However, one of ordinary skill in the art will realize the invention is able to be practiced without the use of these specific details. Particularly, one of ordinary skill in the art will recognize that some embodiments of the invention are able to be practiced with other electronic systems and components. Throughout the description similar components are similarly marked in order to aid comprehension.

Embodiments of the present invention are directed to an apparatus, system and method for remotely communicating with an electronic device and a stereo system. In some embodiments, the stereo system is hermetically sealed and ingression protection rated. In these embodiments, the stereo system is completely sealed from water and environmental intrusion. The stereo system comprises a housing for removably docking and housing an electronic device and a communication device. The communication device comprises a receiver which is configured for receiving a command signal, and a control device which receives a signal from the receiver and sends a signal to one or both of an electronic device operation circuit and a stereo housing operation circuit based upon the signal sent to the receiver. In some embodiments, the command signal sent to the receiver is a voice command Sending a command signal to the receiver and the communication device enables a user to control one or both of the electronic device and the stereo housing. In some embodiments, the communication device comprises a remote control. In some embodiments, the remote control is hermetically sealed and ingression protection rated. In these embodiments, the remote control is completely sealed from water and environmental intrusion.

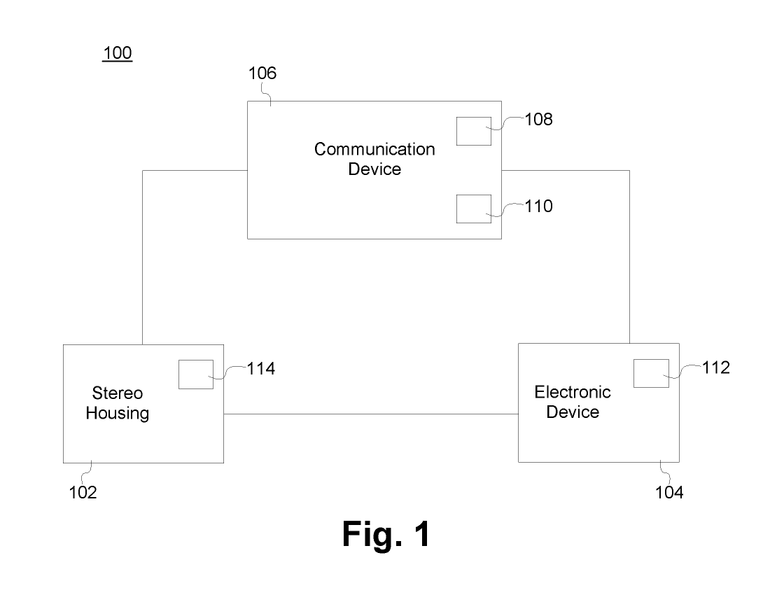

FIG. 1 illustrates a stereo system in accordance with some embodiments. The system 100 comprises a stereo housing 102 for removably coupling with an electronic device 104 and a communication device 106. In some embodiments, the stereo housing 102 comprises an apparatus for housing a removable electronic device such as described in the co-owned U.S. Pat. No. 7,831,756 and the co-owned U.S. patent application Ser. No. 12/915,967, and entitled “Docking Station for an Electronic Device”, both of which are hereby incorporated by reference. In these embodiments, when the electronic device 104 is coupled with the stereo housing 102, the electronic device 104 is docked within and completely enclosed within an enclosure of the stereo housing 102. Alternatively, in some embodiments, the electronic device 104 is wirelessly coupled with the stereo housing 102. In some embodiments the electronic device 104 is a portable digital media device such as an iPod™, Palm™, Zen™, Zune™, or other digital media device such as a tablet, MP3 player or music phone. Particularly, the electronic device 104 is able to comprise any appropriate electronic media player as known in the art. The stereo housing 102 is able to be coupled to one or more of an amplifier, a receiver and speakers in order to power the system. In some embodiments, the system 100 is ingress protection rated and is designed for use in an aquatic environment such as a boat or a spa. In some embodiments, the stereo housing 102 comprises a display screen and is configured to display video files.

In some embodiments, the communication device 106 comprises a receiver 108 for receiving a command signal and a control device 110 for controlling the device 106. The receiver 108 receives a command signal and sends a signal to the control device 110 based upon the command signal. The control device 110 processes the signal from the receiver 106 and sends a sends a signal to one or both of an electronic device operation circuit 212 and a stereo housing operation circuit 214.

As shown within FIG. 1, the two the communication device 106 is coupled to the stereo housing 102 and the electronic device 104. In some embodiments, the communication device 106 is a component of the stereo housing 102. In these embodiments, the device 106 is able to communicate with the electronic device 104 in a wired or wireless manner depending upon the connection of the electronic device 104 with the stereo housing 102. For example, if the electronic device 104 is docked with the stereo housing 102 then the device 106 is able to communicate with the electronic device 104 through the electronic device's 104 docking connection with the housing 102. Alternatively, in some embodiments, the communication device 106 communicates with the electronic device 104 in a wireless manner. Particularly, the communication device 106 is able to communicate with the electronic device 104 independent of the electronic device's 104 connection with the stereo housing 102. In further embodiments, the communication device 106 is separatable from the stereo housing 102. For example, in some embodiments, the device 106 comprises a remote control for controlling the stereo housing 102 and the electronic device 104. In some embodiments, the remote control is hermetically sealed and ingression protection rated. In these embodiments, the remote control is completely sealed from water and environmental intrusion. In some embodiments, the communication device 106 is able to receive one or more signals from the electronic device 104 and the stereo housing 102. For example, in some embodiments, the communication device 106 comprises a speaker and is able to play media from the stereo housing 102 and the electronic device 104 or answer and talk on a phone call received by the electronic device 106.

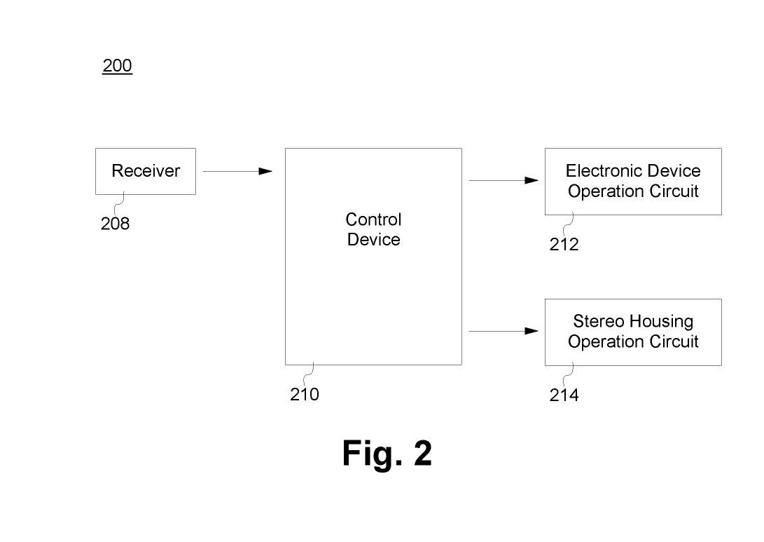

FIG. 2 illustrates a communication device for a stereo housing an electronic device in accordance with some embodiments. In some embodiments, the communication device 200 is for a hermetically sealed stereo housing or electronic docking station such as described above.

As shown in FIG. 2, the communication device 200 comprises a receiver 208, a control device 210, an electronic device operation circuit 212, and a stereo housing operation circuit 214. The receiver 208 receives a command signal and sends a signal to the control device 210 based upon the command signal. The control device 210 processes the signal from the receiver 208 and sends a signal to one or both of the electronic device operation circuit 212 and the stereo housing operation circuit 214. The electronic device operation circuit 212 operates an electronic device based upon the signal from the control device 210 and the stereo housing operation circuit 214 operates a stereo housing based upon the signal received from the control device 210. For example, in some embodiments, the receiver 208 receives a command to adjust the volume of a speaker system connected to the stereo housing. In response, the receiver 208 sends a signal to the control device 210 which processes the signal from the receiver 208 and sends a signal to the stereo housing operation circuit 214 to adjust the volume of the speaker system to a desired level. In some embodiments, the receiver 208 receives a signal to change the media that is playing through the stereo housing. In response, the receiver 208 sends a signal to the control device 210 which processes the signal from the receiver 208 and sends a signal to the stereo housing operation circuit 214 to change the media that is playing through the stereo housing. Particularly, the receiver 208 is able to receive and the control device 210 is able to send any appropriate control signal to the stereo housing operation circuit 214 as known in the art. For example, in some embodiments, the control device 210 sends a signal to the stereo housing to start, stop, pause, power up, or power down the stereo housing.

In further embodiments, the receiver 208 receives a command to operate the electronic device. For example, in some embodiments, the receiver 208 receives a command to answer or dial a phone call. In response, the receiver 208 sends a signal to the control device 210 which processes the signal from the receiver 208 and sends a signal to the electronic device operation circuit 212 to answer or dial the phone call. Particularly, when a user wishes to use the electronic device, the user is able to send a signal to the receiver to operate the electronic device in a desired manner using the components of the stereo housing.

In still further embodiments, the receiver 208 receives a command to operate the electronic device and the housing. For example, in some embodiments, the receiver 208 receives a command to power on or power off the electronic device and the stereo housing. In response, the receiver 208 sends a signal to the control device 210 which processes the signal from the receiver 208 and sends a signal to the electronic device operation circuit 212 and the operation circuit 214 to power on or power off the electronic device and the stereo housing.

In some embodiments, the receiver 208 is a microphone and is configured for receiving voice commands. Alternatively, in some embodiments, the receiver 208 comprises on or more push buttons which are pressed in order to control an aspect of one or both of the stereo housing and the electronic device. As described above, in some embodiments, the communication device is a component of the stereo housing. Alternatively, in some embodiments, the device is a component of a remote control for controlling the stereo housing and the electronic device.

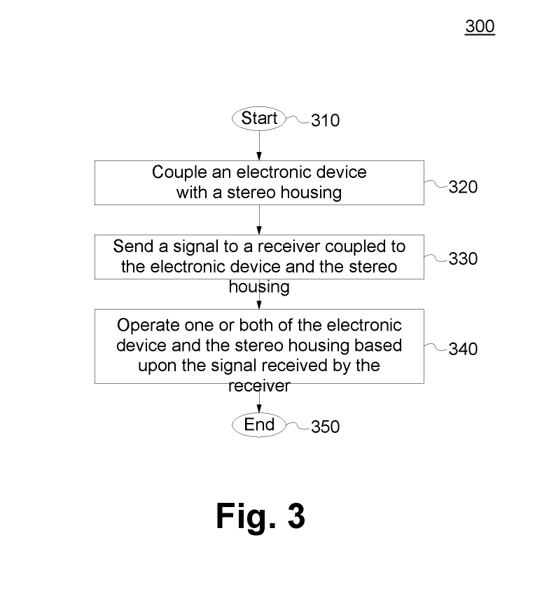

FIG. 3 illustrates a method of remote controlling an electronic device and stereo housing, in accordance with some embodiments. The method starts in the step 310. In the step 320, an electronic device is coupled with a stereo housing. In some embodiments, the electronic device is inserted into the stereo housing and completely enclosed within the housing. In some embodiments, the stereo housing is hermetically sealed and ingress protection rated. Particularly, the stereo housing is coupled to one or more of an amplifier, a stereo receiver and one or more speakers in order to play media located on the electronic device. Then, in the step 330, a signal is sent to a receiver coupled to the electronic device and the stereo housing. As described above, the receiver sends a signal to control device which process the signal from the receiver and sends a signal to one or both of an electronic device operation circuit and a stereo housing circuit. In the step 340, the electronic device, and/or the stereo housing is operated based upon the signal received by the receiver. In some embodiments, the receiver is a microphone and the signal is a voice command Alternatively, in some embodiments the receiver comprises a remote control. In some embodiments, a signal is received at the remote control based upon the signal sent to one or both of the electronic device operation circuit and the stereo housing circuit. In some embodiments, the remote control is hermetically sealed and ingression protection rated. In these embodiments, the remote control is completely sealed from water and environmental intrusion.

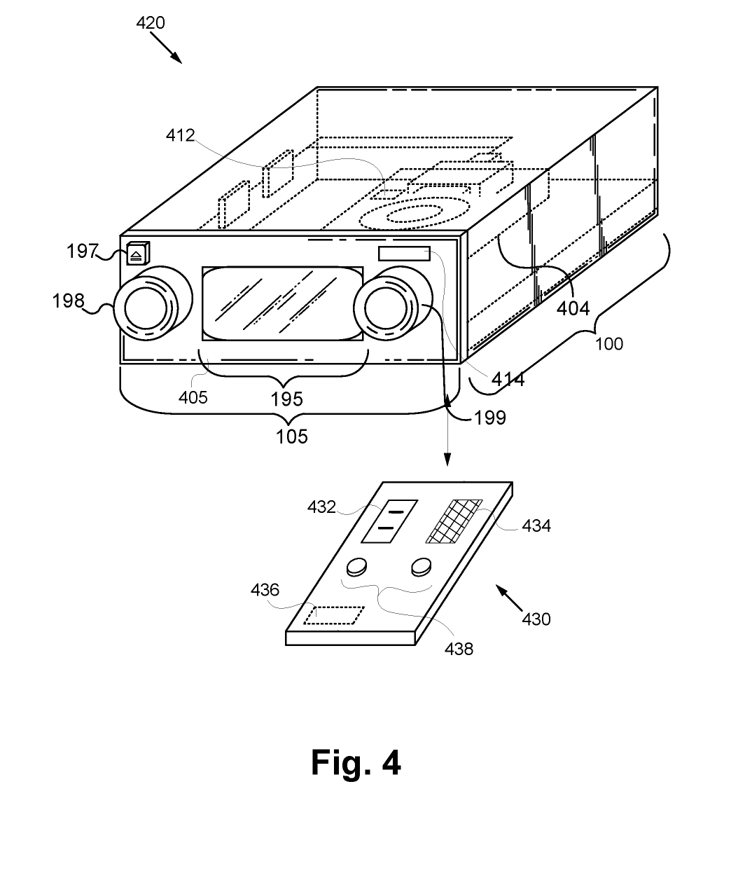

Referring now to FIG. 4, a remote control is shown in communication with a housing unit and an electronic device, in accordance with some embodiments. As shown in FIG. 4, an electronic device 404 has been removably coupled with a housing unit 420. In some embodiments, the electronic device 404 is completely enclosed within the housing unit 420 when it is coupled with the housing unit 420. In some embodiments, to connect the electronic device 404 with the housing unit 420, the user moves a controller interface 405 to an open position. The user then inserts the electronic device 404 into the housing unit 420 and couples the electronic device 404 with a device-housing connector inside the housing unit 420. The user then moves the controller interface 405 to a closed position, forming a waterproof enclosure housing the electronic device 404 within. In some embodiments, the controller interface 405 allows the user to operate the electronic device 404, now safely enclosed within the housing unit 420, and play content, such as music or other audio or video, through a connected audio system. Once the electronic device 404 is coupled within the housing unit 420, the user is able to access and control the functions of the electronic device 404 and the housing unit 420 by using the remote control 430. In some embodiments, the remote control 430 communicates with the electronic device 404 and the housing unit 420 with a wireless technology such as IEEE 802.11, Bluetooth®, Radio Frequency (RF) or any other appropriate wireless methodology.

The remote control 430 comprises a microphone 432 for receiving a voice command or other communication, a controller 436 and a speaker 434. In some embodiments, the remote control 430 is hermetically sealed and ingression protection rated. In these embodiments, the remote control 430 is completely sealed from water and environmental intrusion. In some embodiments, the microphone 432 receives a voice command or other communication from the user and sends a signal to the controller 436. The controller 436 processes the signal from the microphone 432 and sends a signal to one or both of the electronic device operation circuit 412 and the housing unit operation circuit 414. The electronic device operation circuit 412 operates an electronic device based upon the signal from the controller 436 and the housing unit operation circuit 414 operates the housing unit based upon the signal received from the controller 436.

For example, in some embodiments, the microphone 432 receives a voice command to adjust the volume of a speaker system connected to the housing unit 420. In response, the microphone 432 sends a signal to the controller 436 which processes the signal from the microphone 432 and sends a signal to the housing unit operation circuit 414 to adjust the volume of a speaker system coupled to the housing unit 420 to a desired level. In some embodiments, the microphone 432 receives a signal to change the media that is playing through the housing unit 420. In response, the microphone 432 sends a signal to the controller 436 which processes the signal from the microphone 432 and sends a signal to the housing unit operation circuit 414 to change the media that is playing through the stereo housing. Particularly, the microphone 432 is able to receive and the controller 436 is able to send any appropriate control signal to the housing unit operation circuit 414 as known in the art. For example, in some embodiments, the controller 436 sends a signal to the housing unit 420 to start, stop, pause, power up, or power down. In some embodiments, the media of the housing unit 420 is able to be played through the speaker 434. For example, a user is able to utilize the microphone 432 in order to send a voice command in order to play media through the speaker 434 of the remote control 430.

In further embodiments, the microphone 432 receives a command to operate the electronic device 404. For example, in some embodiments, the microphone 432 receives a command to answer or dial a phone call. In response, the microphone 432 sends a signal to the controller 436 which processes the signal from the microphone 432 and sends a signal to the electronic device operation circuit 412 to answer or dial the phone call. Particularly, when a user wishes to use the electronic device, the user is able to send a signal to the receiver to operate the electronic device 404 in a desired manner using the components of the stereo housing. Alternatively, in some embodiments, the phone call is received through the speaker 434 of the remote control 430. For example, a user is able to utilize the microphone 432 in order to send a voice command in order to receive a phone call through the speaker 434 of the remote control 430.

In still further embodiments, the microphone 432 receives a command to operate the electronic device and the housing. For example, in some embodiments, the microphone 432 receives a command to power on or power off the electronic device 404 and the housing unit 420. In response, the microphone 432 sends a signal to the controller 436 which processes the signal from the microphone 432 and sends a signal to the electronic device operation circuit 412 and the housing unit operation circuit 414 to power on or power off the electronic device 404 and the housing unit 420.

As shown in FIG. 4, in some embodiments, the remote control 430 comprises one or more buttons 438. The one or more buttons 438 are able to be used in order to send control signals to one or both of the electronic device 404 and the housing unit 420.

As described above, in some embodiments, the remote control 430 is used as a two-way remote control. In these embodiments, the remote control 430 sends signals to the electronic device 404 and the housing unit 420 and also receives signals from the electronic device 404 and the housing unit 420. Alternatively, in some embodiments, the remote control 430 is used to communicate signals to the electronic device 404 and the housing unit 420 in a one-way manner.

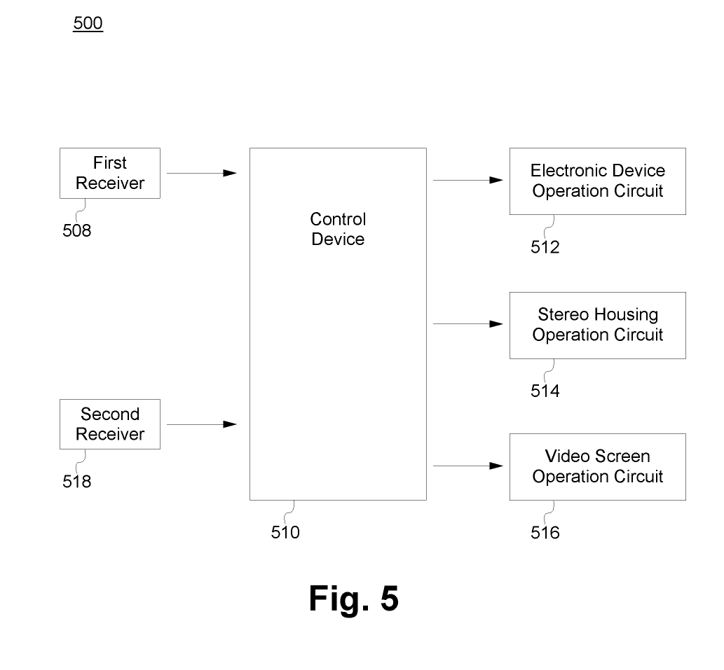

Referring now to FIG. 5, a communication device is depicted therein. The communication device 500 is configured to be used with an electronic device and stereo system and/or audio system comprising a stereo housing such as described above and below.

The communication device 500 is configured to communicate with the electronic device and the stereo housing. The communication device 500 comprises a first receiver 508, a second receiver 518, a control device 510, an electronic device operation circuit 512, a stereo housing operation circuit 514, and a video screen operation circuit 516. In some embodiments, the first receiver 508, the second receiver 518, the control device 510, and the video operation circuit 516 are components of a remote control for controlling the electronic device and the stereo housing. In some embodiments, the remote control is hermetically sealed from water and environmental intrusion.

The first receiver 508 receives a command signal and sends a signal to the control device 510 based upon the command signal. The control device 510 processes the signal from the first receiver 508 and sends a signal to one or more of the electronic device operation circuit 512 and the stereo housing operation circuit 514. As described above, the electronic device operation circuit 512 operates an electronic device based upon the signal from the control device 510 and the stereo housing operation circuit 514 operates a stereo housing based upon the signal from the control device 510.

For example, as described above, in some embodiments, the first receiver 508 receives a command to adjust the volume of a speaker system connected to the stereo housing. In response, the first receiver 508 sends a signal to the control device 510 which processes the signal from the first receiver 508 and sends a signal to the stereo housing operation circuit 514 to adjust the volume of the speaker system to a desired level. In some embodiments, the first receiver 508 receives a signal to change the media that is playing through the stereo housing. In response, the first receiver 508 sends a signal to the control device 510 which processes the signal from the first receiver 508 and sends a signal to the stereo housing operation circuit 514 to change the media that is playing through the stereo housing. Particularly, the first receiver 508 is able to receive and the control device 510 is able to send any appropriate control signal to the stereo housing operation circuit 514 as known in the art. For example, in some embodiments, the control device 510 sends a signal to the stereo housing to start, stop, pause, power up, or power down the stereo housing.

In further embodiments, the first receiver 508 receives a command to operate the electronic device. For example, in some embodiments, the first receiver 508 receives a command to answer or dial a phone call. In response, the first receiver 508 sends a signal to the control device 510 which processes the signal from the first receiver 508 and sends a signal to the electronic device operation circuit 512 to answer or dial the phone call. Particularly, when a user wishes to use the electronic device, the user is able to send a signal to the receiver to operate the electronic device in a desired manner using the components of the stereo housing.

In still further embodiments, the first receiver 508 receives a command to operate the electronic device and the housing. For example, in some embodiments, the first receiver 508 receives a command to power on or power off the electronic device and the stereo housing. In response, the first receiver 508 sends a signal to the control device 510 which processes the signal from the first receiver 508 and sends a signal to the electronic device operation circuit 512 and the operation circuit 514 to power on or power off the electronic device and the stereo housing.

In some embodiments, the first receiver 508 is a microphone and is configured for receiving voice commands. Alternatively, in some embodiments, the first receiver 508 comprises on or more push buttons which are pressed in order to control an aspect of one or both of the stereo housing and the electronic device. As described above, in some embodiments, the communication device is a component of the stereo housing. Alternatively, in some embodiments, the device is a component of a remote control for controlling the stereo housing and the electronic device.

The second receiver 518 receives a display signal and sends a signal to the control device 510 based upon the display signal. The control device 510 processes the signal from the second receiver 518 and sends a signal to the video screen operation circuit 516. The video operation circuit 516 operates a video screen based upon a signal from the control device 510. For example, in some embodiments, the video screen is an LCD screen and is a component of the communication device 500. The video screen displays visual content such as song, album, and artist information of the based upon the media that is being played by the electronic device and the stereo housing. Alternatively, in some embodiment, the video screen displays caller identification information of the call received by the electronic device.

In some embodiments, the electronic device is completely enclosed within the stereo housing. Particularly, the communication device 500 is able to utilize a wired or a wireless signal in order to control and receive information from the stereo housing and the electronic device. In some embodiments, the wireless signal used by the communication device 500 comprises one or more of infrared, laser, radio frequency, WiFi, Bluetooth®, and 2.4 Gh. In some embodiments, the communication device 500 utilizes the IAP protocol.

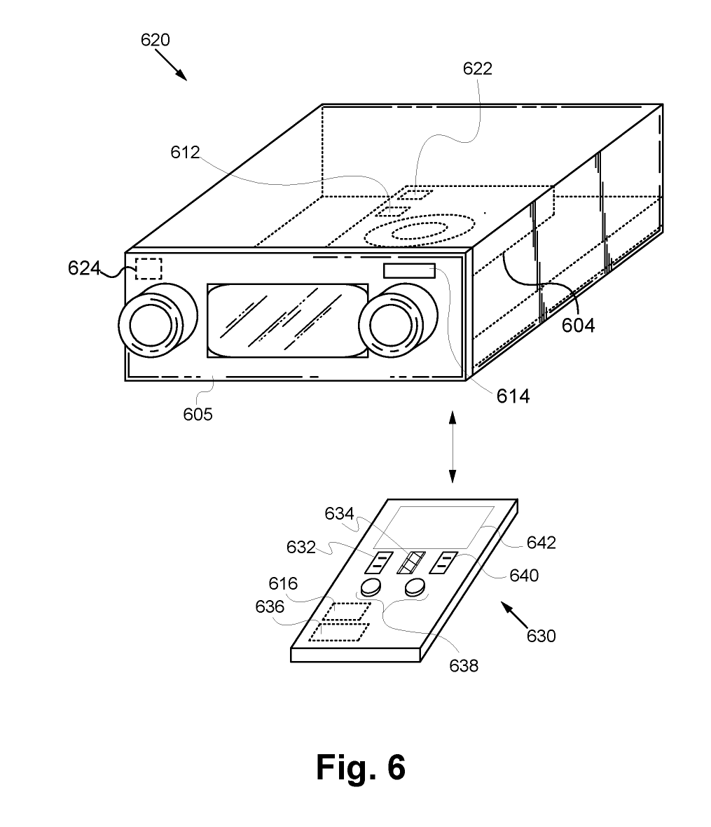

Referring now to FIG. 6, a remote control for communicating with an electronic device and a stereo housing, such as described above, is depicted therein. The remote control 630 is shown in communication with an electronic device 604 and a stereo housing 620, such as shown within FIG. 4. As shown in FIG. 6, an electronic device 604 has been removably coupled with a housing unit 620. In some embodiments, the electronic device 604 is completely enclosed within the housing unit 620 when it is coupled with the housing unit 620. In some embodiments, to connect the electronic device 604 with the housing unit 620, the user moves a controller interface 605 to an open position. The user then inserts the electronic device 604 into the housing unit 620 and couples the electronic device 604 with a device-housing connector inside the housing unit 620. The user then moves the controller interface 605 to a closed position, forming a waterproof enclosure housing the electronic device 604 within. In some embodiments, the controller interface 605 allows the user to operate the electronic device 604, now safely enclosed within the housing unit 620, and play content, such as music or other audio or video, through a connected audio system. Once the electronic device 604 is coupled within the housing unit 620, the user is able to access and control the functions of the electronic device 604 and the housing unit 620 by using the remote control 630. In some embodiments, the remote control 630 communicates with the electronic device 604 and the housing unit 620 with a wireless technology such as IEEE 802.11, Bluetooth®, Radio Frequency (RF), 2.6 Gh or any other appropriate wireless methodology. In some embodiments, the remote control 630 communicates with the electronic device 604 and the housing unit 620 using the IAP protocol.

The remote control 630 works similarly to the remote control 430 such as described above, and comprises a microphone 632 for receiving a voice command or other communication, a remote control speaker 634, a controller 636, a video screen operation circuit 616, and a video screen 642 that displays visual content received from the electronic device 604 and the stereo housing 620. Although a video screen 642 is shown in FIG. 6, in some embodiments, there is no video screen 642 similar to as shown in FIG. 4. In some embodiments, the remote control 630 is hermetically sealed and ingression protection rated. In these embodiments, the remote control 630 is completely sealed from water and environmental intrusion. As shown in FIG. 6, in some embodiments, the remote control 630 comprises one or more buttons 638. The one or more buttons 638 are able to be used in order to send control signals to one or both of the electronic device 604 and the housing unit 620. As described above, in some embodiments, the remote control 630 is used as a two-way remote control. In these embodiments, the remote control 630 sends signals to the electronic device 604 and the housing unit 620 and also receives signals from the electronic device 604 and the housing unit 620. Alternatively, in some embodiments, the remote control 630 is used to communicate signals to the electronic device 604 and the housing unit 620 in a one-way manner. In some embodiments, the remote control 630 comprises replaceable and/or rechargeable batteries.

The microphone 632 receives a voice command or other communication from the user and sends a signal to the controller 636. The controller 636 processes the signal from the microphone 632 and sends a signal to one or both of the electronic device operation circuit 612 and the housing unit operation circuit 614. The electronic device operation circuit 612 operates an electronic device based upon the signal from the controller 636 and the housing unit operation circuit 614 operates the housing unit based upon the signal received from the controller 636. For example, in some embodiments, the microphone 632 receives a voice command to adjust the volume of a speaker system connected to the housing unit 620. In response, the microphone 632 sends a signal to the controller 636 which processes the signal from the microphone 632 and sends a signal to the housing unit operation circuit 614 to adjust the volume of a speaker system coupled to the housing unit 620 to a desired level. In some embodiments, the microphone 632 receives a signal to change the media that is playing through the housing unit 620. In response, the microphone 632 sends a signal to the controller 636 which processes the signal from the microphone 632 and sends a signal to the housing unit operation circuit housing unit operation circuit 614 to change the media that is playing through the stereo housing 620. Particularly, the microphone 632 is able to receive and the controller 636 is able to send any appropriate control signal to the housing unit operation circuit 614 as known in the art. For example, in some embodiments, the controller 636 sends a signal to the housing unit 620 to start, stop, pause, power up, or power down. In some embodiments, the media of the housing unit 620 is able to be played through the speaker 634. For example, a user is able to utilize the microphone 632 in order to send a voice command in order to play media through the speaker 634 of the remote control 630.

In further embodiments, the microphone 632 receives a command to operate the electronic device 604. For example, in some embodiments, the microphone 632 receives a command to answer or dial a phone call. In response, the microphone 632 sends a signal to the controller 636 which processes the signal from the microphone 632 and sends a signal to the electronic device operation circuit 612 to answer or dial the phone call. In some embodiments, the phone call is received through the speaker 634 of the remote control 630. Alternatively, in some embodiments, the phone call is able to be played through one or more speakers connected to the stereo housing 620. Particularly, a switch 640 is able to be used to transfer the phone call between the speaker 634 of the remote control 630 and one or more speakers of the stereo housing 620. In this manner, a user is able to participate in a conversation using an audio system or privately through the remote 630. In some embodiments, the audio from the electronic device 604 is received by the remote 630 through a wireless connection and transferred to the one or more speakers of the stereo housing 620 using the same or different wireless connection.

Using the microphone 632 the user is able to make and receive calls and operate the electronic device 604 simply by speaking into the microphone 632. For example, a user may say “call mom” or other voice command into the microphone 632 and the electronic device 604 initiates a phone call to “mom.” Additionally, in some embodiments, a user speaks voice commands into the microphone 632 so that the electronic device 604 initiates another operation. For example, a user may ask “what restaurants are in the area.” In response, the microphone 632 sends a signal to the controller 636 which processes the signal from the microphone 632 and sends a signal to the electronic device operation circuit 612 to look up nearby restaurants and play the answer through the speaker 634 of the remote control 630 or stereo housing 620, such as described above, or display the answer on the video screen 642.

In still further embodiments, the microphone 632 receives a command to operate the electronic device and the housing. For example, in some embodiments, the microphone 632 receives a command to power on or power off the electronic device 604 and the housing unit 620. In response, the microphone 632 sends a signal to the controller 636 which processes the signal from the microphone 632 and sends a signal to the electronic device operation circuit 612 and the housing unit operation circuit 614 to power on or power off the electronic device 604 and the housing unit 620.

The video screen 642 displays visual content received from the electronic device 604 and the stereo housing 620. In some embodiments, the video screen is an LCD screen. Particularly, the video operation circuit 616 operates the video screen 642 based upon a signal from the controller 636. For example, in some embodiments, the controller 636 receives a signal from a transmitter 622 of the electronic device 604 based upon the media being played by the electronic device 604. The controller 636 processes the signal from the transmitter 622 and sends a signal to the video screen operation circuit 616 to display visual content. In some embodiments, the transmitter 622 sends a signal to the video operation circuit 616 based upon the music being played by the electronic device 604 and the video screen 642 displays one or more of the album, artist, and song information correlated to the music being played. In some embodiments, if the electronic device 604 has received or is making a telephone call, the transmitter 622 sends a signal to the video operation circuit 616 and the video screen displays the caller identification information. Alternatively, or in conjunction, the controller 616 receives a signal from a transmitter 624 of the stereo housing 620 based upon the media being played through the stereo housing 620 and a phone call being played through one or mor speakers of the stereo housing. The controller 636 processes the signal from the transmitter 624 and sends a signal to the video screen operation circuit 616 to display the visual content.

In some embodiments, the remote control 630 is configured to download information based upon a signal or command received by the microphone 632. For example, the microphone 632 receives a command to play a certain song or album and the corresponding information is sent to the video screen operation circuit 616 and the video screen 642 displays the information.

Additionally, although the video screen 642 is shown as a component of the larger controller 630. In some embodiments, the video screen 642 comprises a touch screen and the remaining components are contained with the touch screen controller.

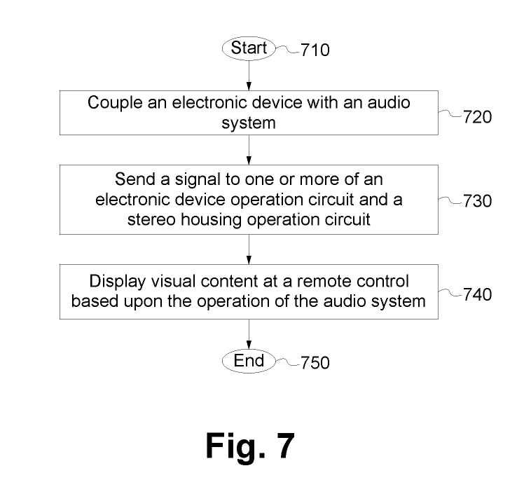

FIG. 7 illustrates a method of operating an audio system. The method begins in the step 710. In the step 720, an electronic device is coupled with an audio system. In some embodiments, the electronic device is inserted into the stereo housing and completely enclosed within the housing. In some embodiments, the stereo housing is hermetically sealed and ingress protection rated. Particularly, the stereo housing is coupled to one or more of an amplifier, a stereo receiver and one or more speakers in order to play media located on the electronic device. In the step 730, a signal is sent to one or more of an electronic device operation circuit and a stereo housing operation circuit to operate one or more of the electronic device and the stereo housing, such as described above. In some embodiments, the signal is one or more of infrared, laser, radio frequency, WiFi, Bluetooth®, and 2.4 Gh. In some embodiments, the signal utilizes the IAP or the A2DP protocol. Then, in the step 740 visual content is displayed at a remote control based upon the operation of the audio system. The video screen displays visual content such as song, album, and artist information of the based upon the media that is being played by the electronic device and the stereo housing. Alternatively, in some embodiment, the video screen displays caller identification information of the call received by the electronic device. Then, in the step 750, the method ends.

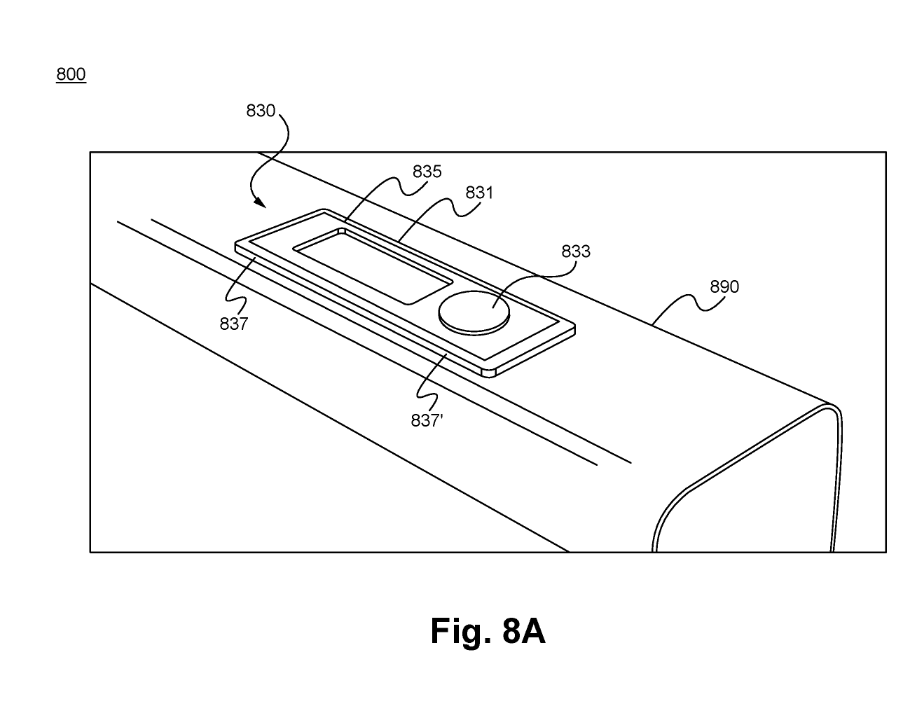

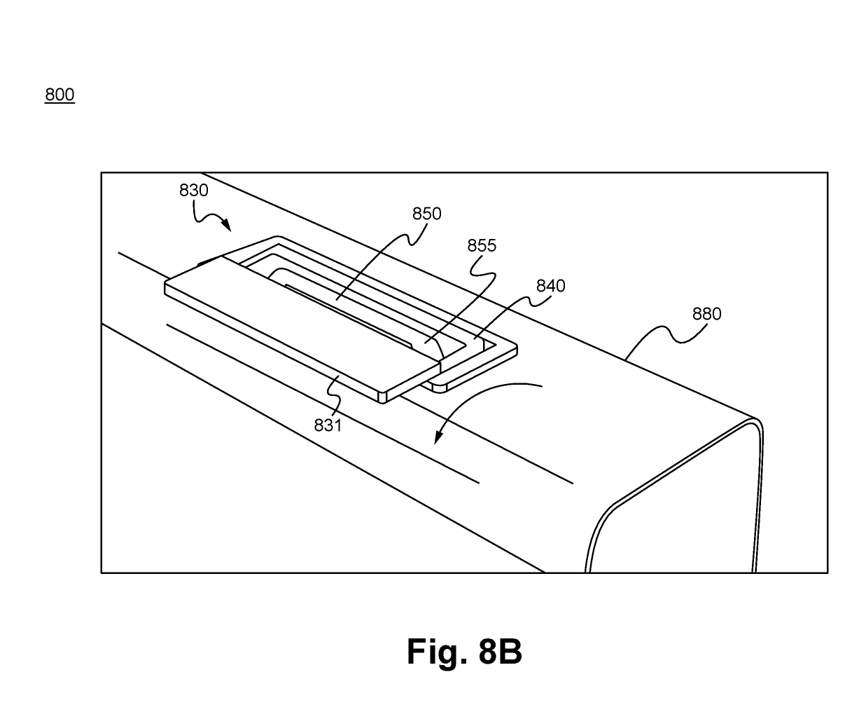

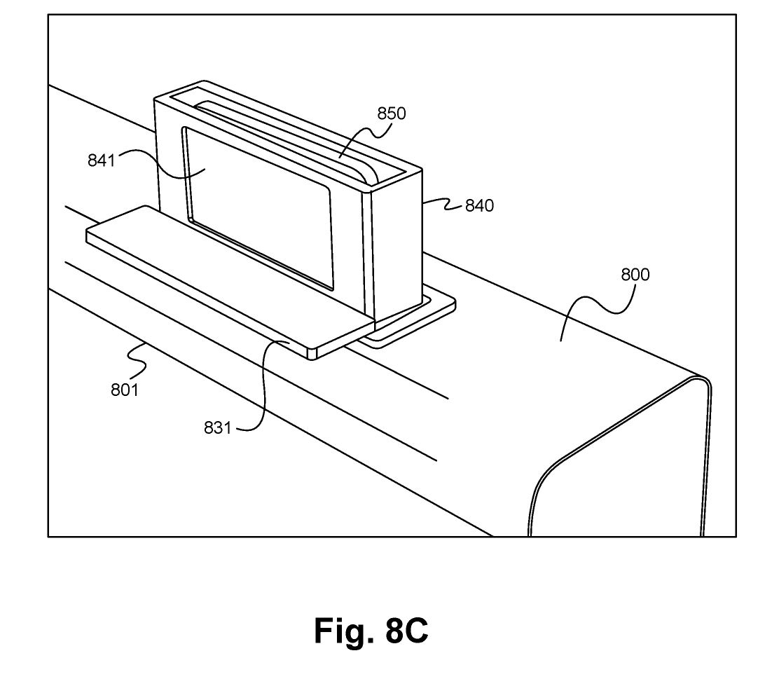

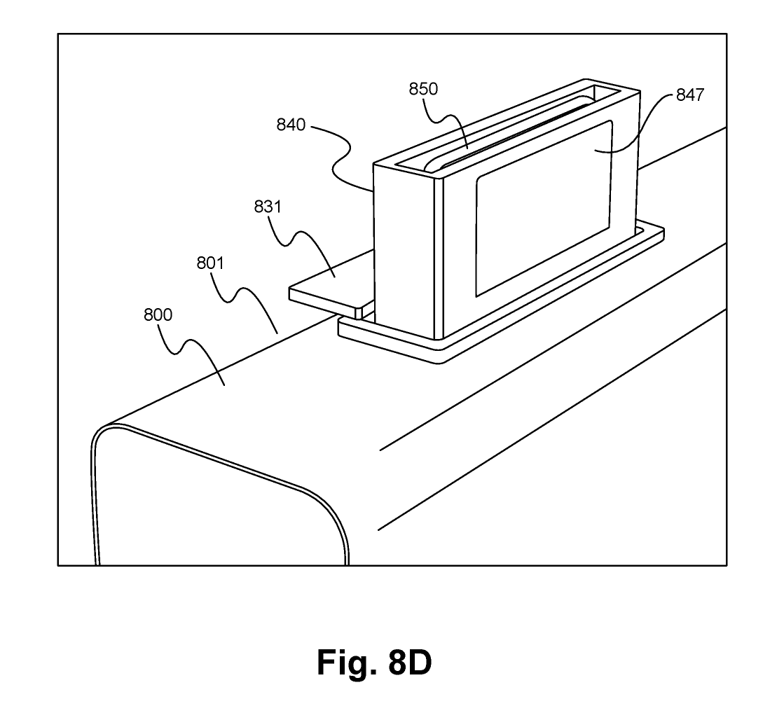

In a further aspect, a control device and/or a remote control is configured to be used with a spa or a pool. Referring now to FIG. 8A, a control device for a pool or a spa is depicted therein. The control device 800 comprises a housing 830 that is configured to fit in a frame 880 of a spa and/or a pool. The housing 830 is configured so that a cover 831 of the control device body 840 (FIG. 8B) fits flush with the housing 830 and the frame 880 of the pool when the body 840 is located within the housing 830. As shown within FIG. 8A, the body 840 comprises a cover 831 which comprises a control pad 835 for controlling one or more components of the pool or the spa. In some embodiments, the control pad 835 comprises a touch screen and/or touch sensitive controller for controlling the one or more components. In some embodiments, the cover 831 also comprises a knob for adjusting the one or more components of the spa. As shown within FIG. 8A, the control pad 845 is substantially parallel to and flush with the housing 830. This enables the control pad 845 to be read and used while within the spa or pool and while outside the spa or pool. As further shown in FIG. 8A, in some embodiments, the cover comprises one or more hinges 837 and 837′ which allow the cover 831 to rotate with respect to the housing 830 and the frame 880. In some embodiments, the cover 831 is able to slidably move with respect to the housing 830 and the frame 880.

FIG. 8B illustrates the cover 831 rotated to an open position as indicated by the arrow. When the cover 831 is rotated to an open position, a body 840 is visible and is able to move into and out of the housing 830. The body 840 is contained within the housing 830 and is able to pop up and out of the housing as particularly shown in FIG. 8C. The body 840 is sealed within the housing 830 when the body 840 is located within the housing 830 and the cover 831 is closed. Particularly, the body 840 is sealed such that the interior electronic components of the body 840 are protected from damage. For example, in some embodiments, when the body 840 is located within the housing 830 and the cover is closed 831, the body is sealed with an Ingress Protection (IP) rating of at least 4 or at least 5. Ingress Protection (IP) ratings are a standard which specify the environmental protection that an enclosure provides. As indicated within Table 1, below, an IP rating of at least 4 indicates that the enclosure is protected against water sprayed from all directions, with limited ingress permitted. An IP rating of at least 5 indicates that the enclosure is protected against low pressure jets of water from all directions, with limited ingress permitted. The control device 800 is able to be manufactured to achieve a desired level of seal and protection as appropriately needed. For example, in some embodiments, when the body 840 is located within the housing 830 and the cover is closed 831, the body is sealed with an IP rating between 4 and 6.

TABLE 1

| IP | |
|---|---|
| Value | Protection Against Ingress of Liquids |
| 0 | No protection |
| 1 | Protection against vertically falling drops of water e.g. condensa- |
| | tion |
| 2 | Protection against direct sprays of water up to 15° from the vertical |
| 3 | Protection against direct sprays of water up to 60° from the vertical |
| 4 | Protection against water sprayed from all directions- limited ingress |
| | permitted |
| 5 | Protection against low pressure jets of water from all directions- |
| | limited ingress permitted |
| 6 | Protection against high pressure jets of water from all directions- |
| | limited ingress permitted |
| 7 | Protected against immersion between 15 cm and 1 m |
| 8 | Protected against long periods of immersion under pressure |

Additionally, in some embodiments, when the body 840 is located within the housing 830 and the cover is closed 831, the body 840 is sealed against dust and other air contaminants. For example, in some embodiments, the body 840 is sealed with an IP rating for solids of 5, indicating that the body is dust protected and ingress of dust is not entirely prevented, does not enter in sufficient quantity to interfere with the satisfactory operation of the equipment and with complete protection against contact. Alternatively, in some embodiments, the body 840 is sealed with an IP rating for solids of 6, indicating that the body 840 is dust tight such that there is no ingress of dust and there is a complete protection against contact. However, the control device 800 is able to be manufactured to achieve a desired level of liquid and solid protection, such as described above.

As further shown in 8B, in some embodiments, the body 840 comprises a compartment 850 for receiving an electronic device 855. In some embodiments, the compartment 850 comprises a docking station, such as described above, for receiving the electronic device. In some embodiments, the electronic device 855 is able to wirelessly communicate with the body 840.

As shown within FIG. 8C, the body 840 has been moved out of the housing 830. Particularly, the body 840 is configured to pop up and out of the housing 830 to the open position. In some embodiments, the body 840 comprises a touch screen 841 for controlling the one or more components of the pool or the spa. In some embodiments, the touch screen 841 comprises a touch sensitive controller for controlling the one or more components. In some embodiments, the touch screen 841 is used to control an electronic device located within the compartment 850 of the housing 840. The touch screen 841 may be used to play the electronic device through an audio system of the pool or spa. As further shown within FIGS. 8C and 8D, in some embodiments, the housing 840 comprises a touch screen 841 on the outside of the housing 840 and a touch screen 849 on the inside of the body 840. Consequently, the body 840 may be read and used while within the spa or pool and while outside the spa or pool.

In some embodiments, the touch screen 841 comprises a video screen that displays visual content based on content playing through an audio system of the pool and/or spa. In some embodiments, the visual content comprises song, album, and artist information. In further embodiments, the visual content comprises caller identification information of a call received by the electronic device. In some embodiments, the audio content comprises a phone call. The control device 800 is configured to send and receive a wireless signal comprising one or more of infrared, infrared laser, radio frequency, wireless, WiFi, Bluetooth®, 2.4 Gh, IAP, and A2DP protocol.

In some embodiments, the body 840 and the housing 830 are controllable with a remote control, such as described above. Alternatively, in some embodiments the the body 840 and the housing 830 are controllable with a remotely located electronic device. In addition, the control device 800 is able to be used with and without an electronic device located within the compartment 850. In some embodiments, the one or more components of the pool or the spa comprise an audio component and a control component, such as a jet or temperature control.

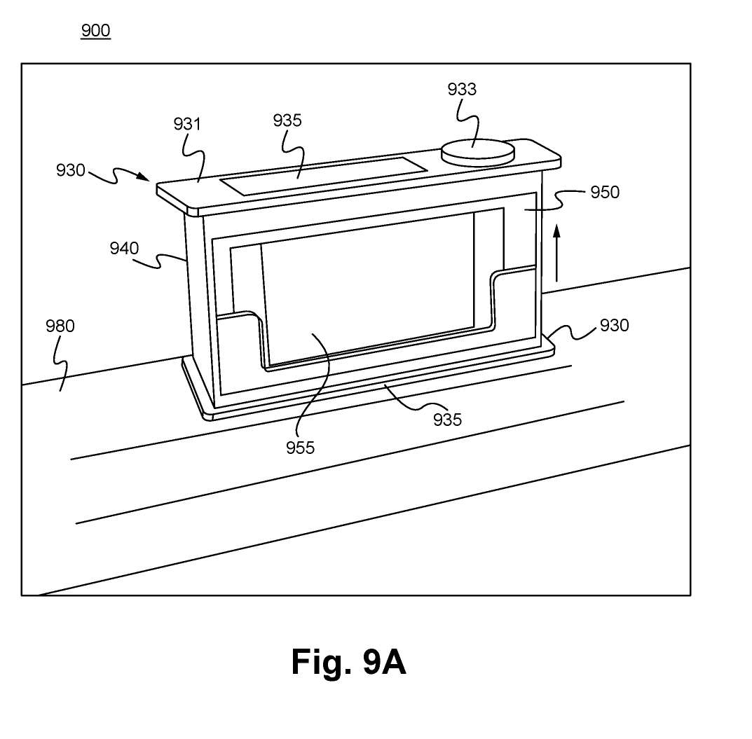

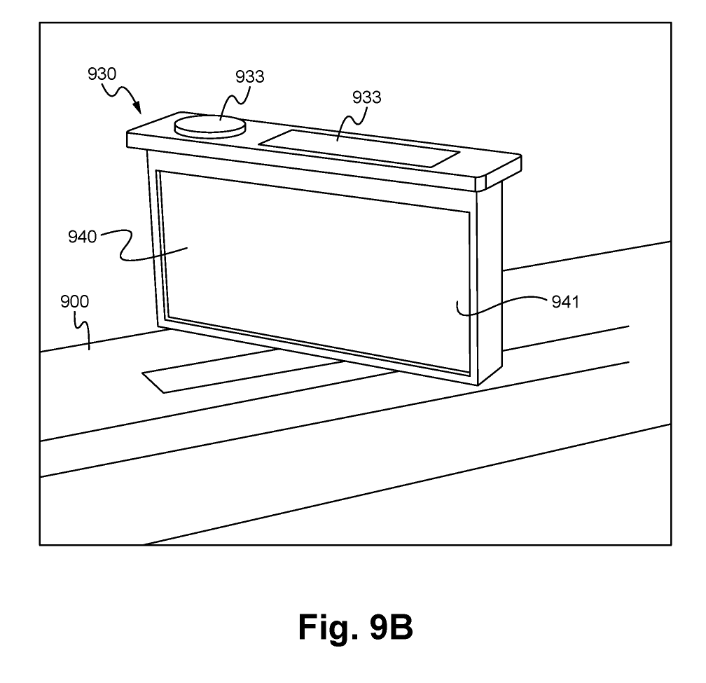

Referring now to FIG. 9A, a control system for a spa or a pool is depicted therein. The system 900 comprises a housing 930 that is configured to fit in a frame 990 of a spa and/or a pool. Similar to the housing 830 of the device 800, as described above, the housing 930 is configured so that a cover 941 of the control device body 940 (FIG. 9B) fits flush with the housing 930 and the frame 980 of the pool when the body 940 is located within the housing 930. As shown within FIG. 9A, the body 940 comprises a cover 941 which comprises a control pad 945 for controlling one or more components of the pool or the spa. In some embodiments, the cover 941 is rotatable and/ or slidable, as described above.

As shown within FIG. 9A, the body 940 has popped up and is outside of the housing 930. In some embodiments, such as described above, a touch screen is used to control the one or more components of the pool or the spa. In some embodiments, a remote control, such as described above, is used to communicate with the system 900. In some embodiments, the body 940 comprises a compartment 950 for receiving an electronic device 955. In some embodiments, the compartment 950 comprises a docking station, such as described above, for receiving the electronic device. In some embodiments, the electronic device 955 is able to wirelessly communicate with the body 940. When the body 940 is enclosed within the housing 930 and the cover 941 is flush with the housing 930 and the frame 980 the body 940 and the electronic device 955 are sealed from water and other intrusions. For example, in some embodiments, when the body 940 is located within the housing 930 and the cover 941 is closed, the body is sealed with an Ingress Protection (IP) rating of at least 4 or at least 5, such as described above. However, the electronic device 955 and the body 940 are able to be sealed to any appropriately desired level of liquid and solid protection, such as described above.

As shown within FIG. 9B, when the body 940 is popped up so that it is located outside of the housing 930, the body is able to be rotated. In some embodiments, the body 940 is able to be rotated 180°. For example, in some embodiments, the electronic device 955 is coupled with the compartment 950 and then the body 940 is rotated 180° so that the touch screen 941 is able to be used to control one or more components of the pool or spa. In some embodiments, an angle of the body 940 is also adjustable with respect to the housing 930 and the frame 980 so that it is easier to read the touch screen 941.

In some embodiments, the touch screen 941 comprises a video screen that displays visual content based on content playing through an audio system of the pool and/or spa. In some embodiments, the visual content comprises song, album, and artist information. In further embodiments, the visual content comprises caller identification information of a call received by the electronic device. In some embodiments, the audio content comprises a phone call. The system 900 is configured to send and receive a wireless signal comprising one or more of infrared, infrared laser, radio frequency, wireless, WiFi, Bluetooth®, 2.4 Gh, IAP, and A2DP protocol.

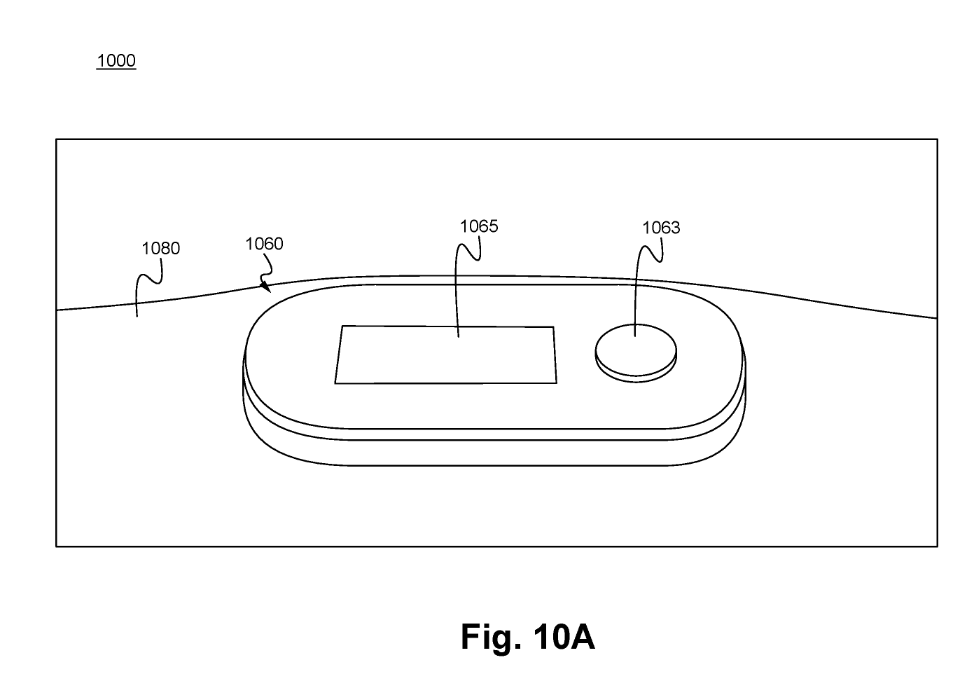

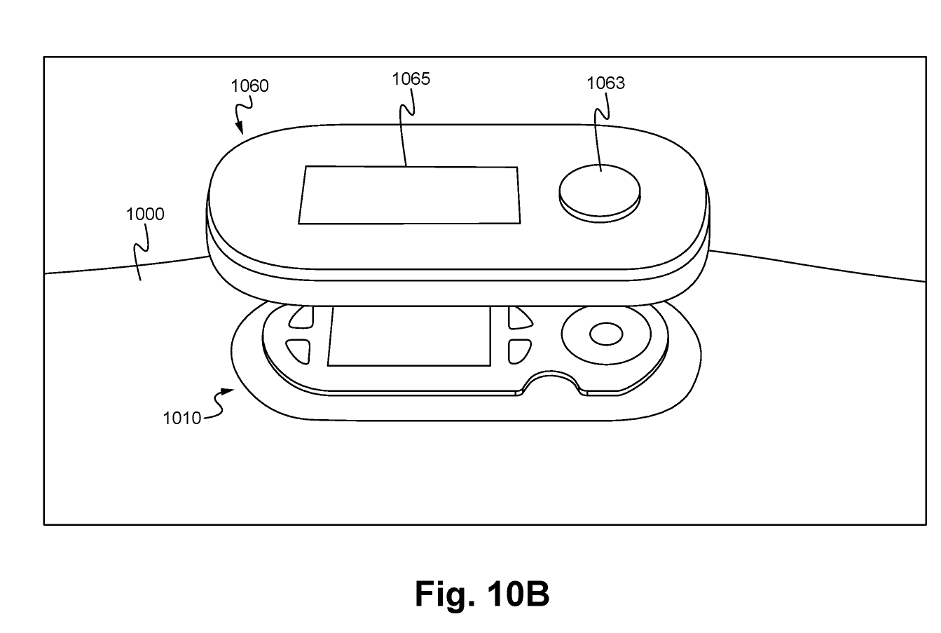

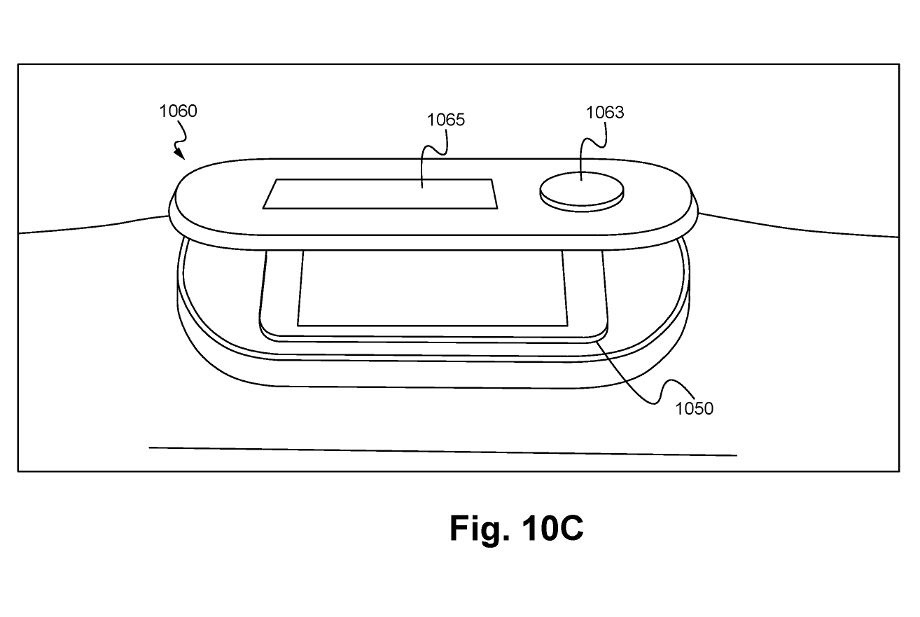

In further embodiments, one or more components of the pool and/or spa are able to be controlled by a spa controller. Referring now to FIG. 10A, a spa controller is shown therein. The spa controller 1000 is configured to communicate with one or more components of a pool and/or a spa. The spa controller 1000 comprises a controller body 1060, comprising a control pad 1065 for controlling one or more components of the pool or the spa. In some embodiments, the control pad 1065 comprises a touch screen and/or touch sensitive controller for controlling the one or more components. In some embodiments, the body 1060 also comprises a knob 1063 for adjusting the one or more components of the spa. In some embodiments, the control pad 1065 comprises a screen which is able to display visual content based on content playing through an audio system of the pool and/or spa. In some embodiments, the visual content comprises song, album, and artist information. In further embodiments, the visual content comprises caller identification information of a call received by the electronic device. In some embodiments, the audio content comprises a phone call. The controller 1000 is configured to send and receive a wireless signal comprising one or more of infrared, infrared laser, radio frequency, wireless, WiFi, Bluetooth®, 2.4 Gh, IAP, and A2DP protocol. The controller 1000 is able to comprise more or less features such as described in relation to the remote control above.

As shown within FIG. 10B, the body 1060 of the controller 1000 is configured to removably couple with a existing spa or pool control 1010. In some embodiments, the body 1060 comprises a cavity which enables the body to removably snap fit over the control 1010. When the body 1060 is coupled with the control 1010, the controller is configured so that it is able to be read and used while inside the pool or spa and outside of the pool or spa. The controller is able to comprise a replaceable and/or a rechargeable battery as appropriately desired.

As shown within FIG. 10C, the body 1060 comprises a compartment 1050 for removably receiving an electronic device 1055, such as described above. In some embodiments, the compartment 1050 comprises a docking station, such as described above, for receiving the electronic device. In some embodiments, the electronic device 1055 is able to wirelessly communicate with the body 1060. When the electronic device 1055 is received within the compartment 1055 it is sealed from water and other environmental intrusion. For example, in some embodiments, when the electronic device 1055 is received within the compartment 1055, the electronic device 1055 is sealed with an Ingress Protection (IP) rating of at least 4 or at least 5, such as described above. However, the electronic device 1055 is able to be sealed to any appropriately desired level of liquid and solid protection, such as described above.

As described in relation to the remote control for communicating with an electronic device described above, in some embodiments, the device 800, system 900, and controller 1000 are able to display visual content based on content of the electronic device. In some embodiments, the visual content comprises song, album, and artist information. In further embodiments, the visual content comprises caller identification information of a call received by the electronic device. Particularly, the visual content can comprise any appropriately desired visual content, such as MP-4 format or DivX Media Format and any appropriate audio or video recording and transmission format. In some embodiments, information can be displayed at the spa but not at the controller 1000. Additionally, the device 800, system 900, and controller 1000 may be used to control one or more components of a pool and/ or a spa such as a speaker system and one or more jets or water control components. Additionally, in some embodiments, the device 800, system 900, and controller 1000 are usable with a microphone for voice commands to control one or more components of a pool and/ or a spa such as a speaker system and one or more jets or water control components, and temperature components.

The electronic device and stereo housing described herein provides an easy and convenient way to play and control an electronic device and stereo housing as part of an audio system. Particularly, a user is easily able to play and control the electronic device while it is coupled with the stereo housing and stored in a convenient and secure location. In some embodiments, the electronic device is substantially sealed within the system to a desired level of protection such that a user is able to control the device in a wet environment such as a spa, a pool, a steam room, and a sauna and with a waterproof remote control and without fear of damaging the audio system or the electronic device. Consequently, the user is able to enjoy use of the electronic device without worrying that the device may become damaged by water or environmental intrusion. The electronic device and stereo housing described herein enables a user to conveniently utilize an electronic device and audio system in many different environmental settings. Particularly, although the electronic device and stereo housing is shown being used with an aquatic environment, the electronic device and stereo housing can be used in any appropriately desired setting. For example, in some embodiments, the electronic device and housing is usable with a motorcycle, an ATV or a SUV, and other applications where a user desires to protect and utilize the electronic device.

Additionally, a controller enables information to be displayed at a remote location corresponding to the media being played by the electronic device coupled with the stereo housing. Particularly, a video screen is able to display album, song, and artist information directly to the user holding the remote control. Additionally, a user is able to view caller identification information corresponding to a call received by an electronic device as well as transfer the call between the remote control and the stereo housing. Accordingly, the device, system and controller described herein has numerous advantages.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications can be made in the embodiment chosen for illustration without departing from the spirit and scope of the invention. Specifically, it will be apparent to one of ordinary skill in the art that the device and method of the present invention could be implemented in several different ways and have several different appearances.

What is claimed is:

1. A control device for an aquatic environment comprising:
a. a housing configured to fit within a frame of the pool or the spa;
b. a body movable into and out of the housing; and
c. a cover that covers the body when it is in the housing, the body comprising a control pad for controlling one or more components of the aquatic environment.

2. The control device of claim 1, wherein the control pad is usable from within the pool and outside of the pool.

3. The control device of claim 1, wherein the touch pad is configured to control one or more of an audio system and one or more pool or spa jets.

4. The control device of claim 1, wherein the cover is rotatable to an open position wherein the body is configured to move out of the housing when the cover is rotated to the open position.

5. The control device of claim 1, wherein the cover is slidable to an open position wherein the body is configured to move out of the housing when the cover is slid to the open position.

6. The control device of claim 1, wherein the body is configured to pop up and out of the housing.

7. The control device of claim 1, wherein the body is rotatable when it is out of the housing.

8. The control device of claim 1, wherein the body is tiltable when it is out of the housing.

9. The control device of claim 1, wherein the body comprises a touch screen for controlling the one or more components of the pool or the spa.

10. The control device of claim 9, wherein the body comprises a touch screen on a front side of the body and a back side of the body.

11. The control device of claim 1, wherein the control device is controllable from a remotely located electronic device.

12. The control device of claim 1, wherein the control device is configured to receive voice commands.

13. The control device of claim 12, wherein the control device comprises a noise cancellation device for cancelling ambient noise.

14. The control device of claim 1, wherein the control device utilizes one or more of infrared, infrared laser, radio frequency, wireless, WiFi, Bluetooth®, 2.4 Gh, IAP, and A2DP protocol.

15. The control device of claim 1, wherein the aquatic environment comprises one of a pool, a spa, a steam room and a sauna.

16. A control system for an aquatic environment comprising;
a. a housing configured to fit within a frame of the aquatic environment;
b. a body movable into and out of the housing, the body comprising a compartment for receiving an electronic device; and
c. a cover that covers the body when it is in the housing, the body comprising a control pad for controlling the electronic device.

17. The control system of claim 16, wherein the compartment comprises a docking station for the electronic device.

18. The control system of claim 16, wherein the system wirelessly communicates with the electronic device.

19. The control system of claim 16, wherein the housing substantially seals the body when it is in the housing.

20. The control system of claim 19, wherein the housing seals the body with an IP rating of 4 when it is in the housing.

21. The control system of claim 19, wherein the housing seals the body with an IP rating of 5 when it is in the housing.

22. The control system of claim 16, wherein the system comprises a remote control for controlling the system.

23. The control system of claim 16, wherein the electronic device is usable with an audio system of the pool or spa when it is located within the body.

24. The control system of claim 16, wherein the system is configured to receive voice commands.

25. The control system of claim 24, wherein the system comprises a noise cancellation device for cancelling ambient noise.

26. The control system of claim 16, wherein the system utilizes one or more of infrared, infrared laser, radio frequency, wireless, WiFi, Bluetooth®, 2.4 Gh, IAP, and A2DP protocol.

27. The control system of claim 16, wherein the aquatic environment comprises one of a pool, a spa, a steam room and a sauna.

28. A controller for an aquatic environment comprising:
a. a body comprising:
i. an internal cavity for accepting an electronic device; and
ii. a cover comprising a control pad for controlling the electronic device,
wherein the controller is configured to removably couple with an existing controller coupled to the aquatic environment.

29. The controller of claim 28, wherein the spa controller is configured to control one or more components of the pool or the spa.

30. The controller of claim 28, wherein the spa controller is configured to control the one or more components of the pool or the spa when separated from the existing spa controller.

31. The controller of claim 28, wherein the compartment comprises a docking station for the electronic device.

32. The controller of claim 28, wherein the system wirelessly communicates with the electronic device.

33. The controller of claim 28, wherein the housing substantially seals the body when it is in the housing.

34. The controller of claim 33, wherein the housing seals the body with an IP rating of 4 when it is in the housing.

35. The controller of claim 33, wherein the housing seals the body with an IP rating of 5 when it is in the housing.

36. The controller of claim 28, wherein the electronic device is usable with an audio system of the pool or spa when it is located within the body.

37. The controller of claim 28, wherein the controller is configured to utilize voice commands.

38. The controller of claim 37, wherein the controller comprises a noise cancellation device for cancelling ambient noise.

39. The controller of claim 28, wherein the controller utilizes one or more of infrared, infrared laser, radio frequency, wireless, WiFi, Bluetooth®, 2.4 Gh, IAP, and A2DP protocol.

40. The controller of claim 28, wherein the aquatic environment comprises one of a pool, a spa, a steam room and a sauna.
